(19) United States
(12) Patent Application Publication
(10) Pub. No.: US 2021/0176311 A1
(43) Pub. Date: Jun. 10, 2021

(54) METHOD AND SYSTEMS FOR SHARING DATA

(71) Applicant: HARMAN INTERNATIONAL INDUSTRIES, INCORPORATED, Stamford, CT (US)

(72) Inventor: Daniel YANG, Shanghai (CN)

(73) Assignee: HARMAN INTERNATIONAL INDUSTRIES, INCORPORATED, Stamford, CT (US)

(21) Appl. No.: 16/322,885

(22) PCT Filed: Aug. 9, 2016
(86) PCT No.: PCT/CN2016/094200

§ 371 Date: Feb. 1, 2019

(51) Int. Cl. H04L 29/08; H04L 29/06

(52) U.S. Cl. CPC H04L 67/1095; H04L 65/4015; H04L 67/306; H04L 67/1044

(57) ABSTRACT

A method and a system for sharing data are provided. The method includes: receiving, by a network server, a sharing request message from a first node, wherein the sharing request message comprises an account of a second node which provides sharing data; obtaining a sharing record of the second node based on the account of the second node, wherein the sharing record is stored in the network server; identifying a sharing mode of the second node based on the sharing record; and transmitting a reply message to the first node based on the sharing mode of the second node. By employing the method, the screen image of a vehicle can be shared with another through wireless networks.

### CROSS-REFERENCE TO RELATED APPLICATIONS

This application claims priority to and is the national phase of International Application No. PCT/CN2016/094200, filed on Aug. 9, 2016, entitled “METHOD AND SYSTEM FOR SHARING DATA”, the entire disclosure of which are incorporated herein by reference

### TECHNICAL FIELD

The present disclosure generally relates to a method and a system for sharing data.

### BACKGROUND

Nowadays, screen sharing technology has been applied in many areas, such as desktop sharing between personal computers, and screen sharing between mobile phones. The screen sharing technology allows remote observance or control of computers on the network. Moreover, with the development of vehicular communication system, it has become possible to obtain a fast, highly reliable communication network having less difference in time between vehicles at a reasonable price. Therefore, there is need to provide a screen sharing method for the vehicular communication system.

### SUMMARY

In one embodiment, a method for sharing data is provided. The method includes: receiving, by a network server, a sharing request message from a first node, wherein the sharing request message includes an account of a second node which provides sharing data; obtaining a sharing record of the second node based on the account of the second node, wherein the sharing record is stored in the network server; identifying a sharing mode of the second node based on the sharing record; and transmitting a reply message to the first node based on the sharing mode of the second node.

In some embodiments, the sharing mode is a one to one sharing mode, a group sharing mode or a public sharing mode.

In some embodiments, if the sharing mode of the second node is a one to one sharing mode, the sharing record of the second node further includes a predetermined account, and the method further includes: comparing an account of the first node with the predetermined account; and if the account of the first node is the same as the predetermined account, transmitting an address of the second node to the first node.

In some embodiments, if the sharing mode of the second node is a group sharing mode, the sharing record of the second node further includes an account list, and the method further includes: identifying whether the account list includes an account of the first node; and if the account list includes the account of the first node, transmitting the sharing data of the second node to the first node.

In some embodiments, the sharing data includes video data and audio data.

In some embodiments, the sharing data are compressed to stream media data.

In one embodiment, a method for sharing data is provided. The method includes: transmitting, by a first node, a sharing mode message to a network server, wherein the sharing mode message includes a sharing mode of the first node; receiving a data transmission message from the network server, wherein the data transmission message includes a destination address, and the destination address is determined based on the sharing mode of the first node; and transmitting sharing data to the destination address.

In some embodiments, the sharing mode is a one to one sharing mode, a group sharing mode or a public sharing mode.

In some embodiments, if the sharing mode of the first node is a one to one sharing mode, the destination address in the data transmission message is an address of a second node.

In some embodiments, if the sharing mode of the first node is a group sharing mode or a public sharing mode, the destination address in the data transmission message is an address of the network server.

In one embodiment, a method for sharing data is provided. The method includes: transmitting, by a first node, a sharing request message to a network server, wherein the sharing request message includes an account of a second node which provides sharing data; receiving a reply message from the network server, wherein the replay message indicates a sharing mode of the second node; and receiving sharing data from the network server or the second node according to the sharing mode of the second node.

In some embodiments, the sharing mode is a one to one sharing mode, a group sharing mode or a public sharing mode.

In some embodiments, if the sharing mode of the second node is a one to one sharing mode, the first node receives the sharing data from the second node.

In some embodiments, if the sharing mode of the second node is a group sharing mode or a public sharing mode, the first node receives the sharing data from the network server.

In one embodiment, a system for sharing data is provided. The system includes a transceiver, a memory device and a processing device configured to: after the transceiver receives a sharing request message from a first node, obtain a sharing record of a second node based on an account of a second node, wherein the sharing request message includes the account of the second node which provides sharing data, and the sharing record is stored in the memory device; identify a sharing mode of the second node based on the sharing record; and control the transceiver to transmit a reply message to the first node based on the sharing mode of the second node.

In some embodiments, the sharing mode is a one to one sharing mode, a group sharing mode or a public sharing mode.

In some embodiments, if the sharing mode of the second node is a one to one sharing mode, the sharing record of the second node further includes a predetermined account, and the processing device is further configured to: compare an account of the first node with the predetermined account; and if the account of the first node is the same as the predetermined account, control the transceiver to transmit an address of the second node to the first node.

In some embodiments, if the sharing mode of the second node is a group sharing mode, the sharing record of the second node further includes an account list, and the processing device is further configured to: identify whether the account list includes an account of the first node; and if the account list includes the account of the first node, control the transceiver to transmit the sharing data of the second node to the first node.

In one embodiment, a system for sharing data is provided. The system includes a transceiver and a processing device configured to: control the transceiver to transmit a sharing mode message to a network server, wherein the sharing mode message includes a sharing mode of a first node; control the transceiver to receive a data transmission message from the network server, wherein the data transmission message include a destination address where sharing data of the first node is transmitted, and the destination address is determined based on the sharing mode of the first node; and control the transceiver to transmit sharing data to the destination address.

In some embodiments, the sharing mode is a one to one sharing mode, a group sharing mode or a public sharing mode.

In some embodiments, if the sharing mode of the first node is a one to one sharing mode, the destination address in the data transmission message is an address of a second node.

In some embodiments, if the sharing mode of the first node is a group sharing mode or a public sharing mode, the destination address in the data transmission message is an address of the network server.

In one embodiment, a system for sharing data is provided. The system includes a transceiver and a processing device configured to: control the transceiver to transmit a sharing request message to a network server, wherein the sharing request message includes an account of a second node which provides sharing data; control the transceiver to receive a reply message from the network server, wherein the replay message indicates a sharing mode of the second node; and control the transceiver to receive sharing data from the network server or the second node according to the sharing mode of the second node.

In some embodiments, the sharing mode is a one to one sharing mode, a group sharing mode or a public sharing mode.

In some embodiments, if the sharing mode of the second node is a one to one sharing mode, the processing device is configured to control the transceiver to receive the sharing data from the second node.

In some embodiments, if the sharing mode of the second node is a group sharing mode or a public sharing mode, the processing device is configured to control the transceiver to receive the sharing data from the network server.

By employing the method and the system for sharing data, the screen image of a vehicle can be shared with another vehicle through wireless networks.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a flow chart of a method for sharing data according to one or more embodiments;

FIG. 2 schematically illustrates an application scenarios of the method for sharing data according to one or more embodiments;

FIG. 3 schematically illustrates a sharing record according to one or more embodiments;

FIG. 4 schematically illustrates another flow chart of a method for sharing data according to one or more embodiments; and

FIG. 5 schematically illustrates a block diagram of a system for sharing data according to one or more embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

It should be noted that, the terms “first”, “second”, and the like in the description and in the claims, are used to distinguishing between similar elements and do not tend to describe a particular sequential and chronological order.

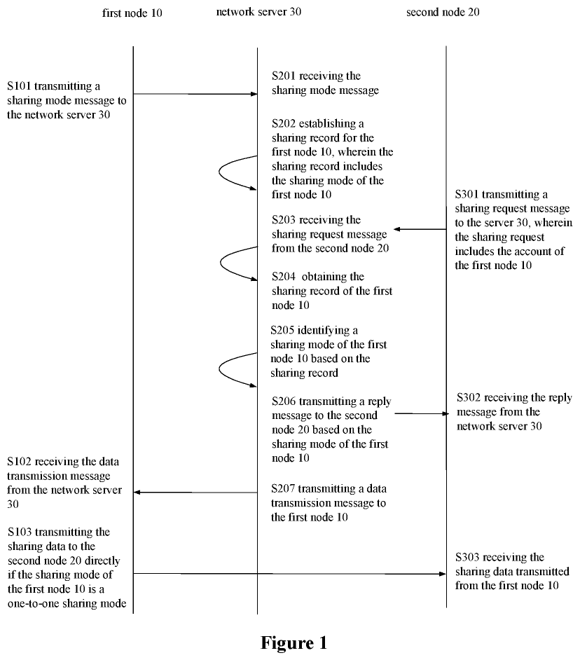

FIG. 1 schematically illustrates a flow chart of a method for sharing data according to one or more embodiment of the present disclosure.

In S101, a first node 10 transmits a sharing mode message to a network server 30. The sharing mode message includes a sharing mode of the first node 10.

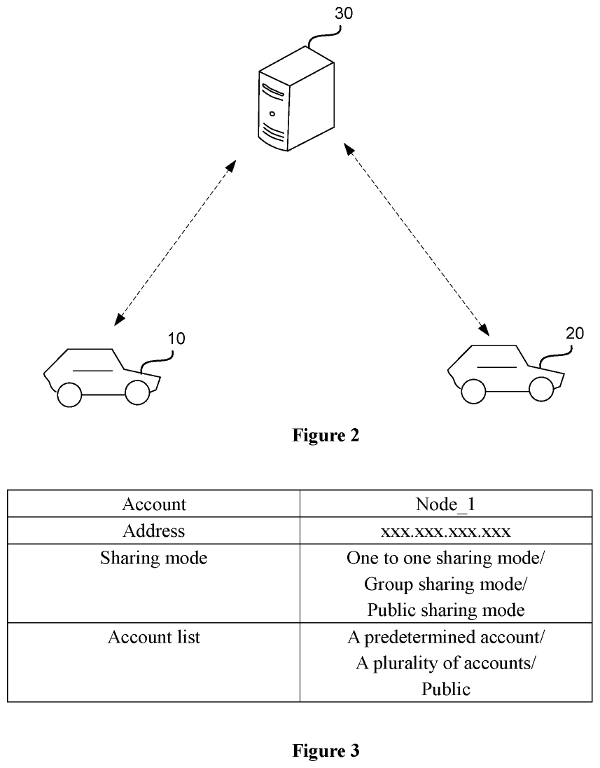

In some embodiments, as shown in FIG. 2, the method of the present disclosure may be implemented on a first vehicle. The first node 10 may be a Head Unit (HU), or a handheld device on the first vehicle.

In some embodiments, the network server 30 is a Telematics Service Provider (TSP) server. The TSP may provide practical applications such as vehicle tracking, satellite navigation, wireless vehicle safety communications, consulting service and emergency warning system for vehicles, and intelligent vehicle technologies.

In some embodiment, the network server 30 is a remoter server which executes a computer program to perform the steps of the method of the present disclosure.

In some embodiments, the sharing mode message further includes an account of the first node 10, and an address of the first node 10.

In some embodiments, the sharing mode of the first node 10 is a public sharing mode, a group sharing mode or a one to one sharing mode. If the sharing mode is a one to one sharing mode or a group sharing mode, the sharing mode message may further includes a predetermined account or a plurality of accounts which are permitted to access sharing data of the first node 10.

It should be noted that, even if the sharing mode of the first node 10 is a public sharing mode, the first node 10 can set a password for its sharing data.

In S201, the network server 30 receives the sharing mode message.

In S202, the network server 30 establishes a sharing record for the first node 10, wherein the sharing record includes the sharing mode of the first node 10.

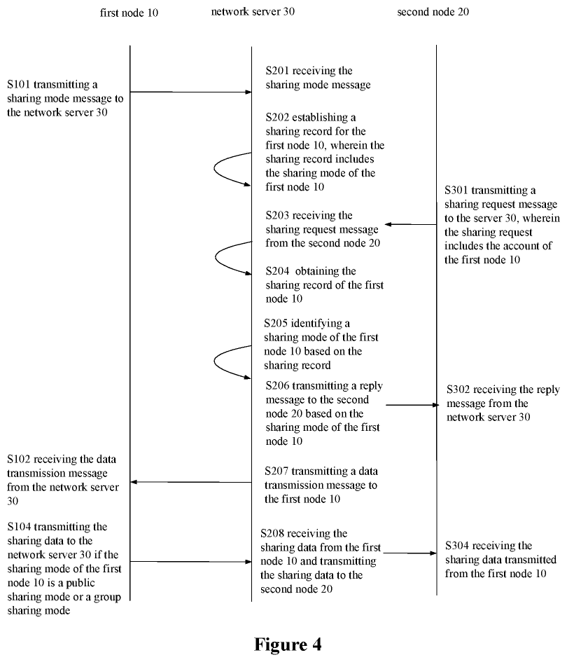

In some embodiments, the sharing record may be stored in a memory device of the network server 30. An example of the sharing record is shown in FIG. 3. As shown in FIG. 3, the sharing record includes the account of the first node 10, the address of the first node 10, and the sharing mode of the first node 10. In some embodiments, the sharing record further includes a permitted account list corresponding to the sharing mode. As stated above, if the sharing mode of the first node 10 is a one to one sharing mode, the permitted account list only includes one predetermined account; if the sharing mode of the first node 10 is a group sharing mode, the permitted account list includes more than one account; and if the sharing mode of the first node 10 is a public sharing mode, the account list includes no account, which means everyone can access the sharing data of the first node 10. In some embodiments, the above information in the sharing record may be obtained based on the sharing mode message.

It should be noted that, when the sharing mode of the first node 10 is a public sharing mode and the first node 10 sets a password for its sharing data, the password may be also saved in the sharing record.

In S301, a second node 20 transmits a sharing request message to the network server 30, wherein the sharing request includes the account of the first node 10.

In some embodiments, as shown in FIG. 2, the method of the present disclosure may be implemented on a second vehicle. The second node 20 may be a Head Unit (HU), or a handheld device on the second vehicle. The first node 10 and the second node 20 may be connected with the network server 30 through wireless networks, such as cellular networks or DSRC (Dedicated Short Range communication) networks. The cellular network may be a 3G network, a 4G network or a 5G network. Thus, the physical wires for connecting the first node 10, the second node 20 and the network server 30 are not needed, and the connection distance is not limited.

In some embodiments, the sharing request message may further include an account of the second node 20 and an address of the second node 20.

In some embodiments, before transmitting the sharing request message, the second node 20 may first transmit a querying message to the network server 30 to determine whether the first node 10 is in a sharing state. If a reply from the network server 30 is yes, the second node 20 transmits the sharing request to the network server 30. Otherwise, the second node 20 doesn't transmit the sharing request message.

In S203, the network server 30 receives the sharing request message from the second node 20, wherein the sharing request message includes the account of the first node 10.

In S204, the network server 30 obtains the sharing record of the first node 10.

In some embodiments, the network server 30 may parse the request message received from the second node 20, and obtain the account of the first node 10. As the sharing record is stored in the network server 30, then the network server 30 may perform a searching process to obtain the sharing record of the first node 10 based on the account of the first node 10.

In S205, the network server 30 identifies a sharing mode of the first node 10 based on the sharing record.

As described above, as the sharing record includes the account, the address and the sharing mode of the first node 10, the network server 30 can identify the sharing mode of the first node 10.

In S206, the network server 30 transmits a reply message to the second node 20 based on the sharing mode of the first node 10.

If the sharing mode of the first node 10 is a one-to-one sharing mode, the network server 30 may determine whether the account of the second node 20 is the same as the predetermined account saved in the sharing record. If yes, the network server 30 may transmit the address of the first node 10 to the second node 20, thus the second node 20 can establish a connection with the first node 10, and obtain the sharing data from the first node 10 directly. If no, the network server 30 may transmit a rejection message, as a reply message to the sharing request message, to the second node 20.

If the sharing mode of the first node 10 is a group sharing mode, the network server 30 may determine whether the account of the second node 20 is in the account list of the sharing record. If yes, the network server 30 transmits an acknowledging message to the second node 20. If no, the network server 30 may transmit a rejection message to the second node 20.

If the sharing mode of the first node 10 is a public sharing mode, the network server 30 transmits an acknowledging message to the second node 20 directly.

In some embodiments, if the sharing mode of the first node 10 is a public sharing mode and the first node 10 set a password for the sharing data, the network server 30 may determine whether the password in the sharing request message matches the password set by the first node 10 and saved in the sharing record. If yes, the network server 30 transmits an acknowledging message to the second node 20. If no, the network server 30 may transmit a rejection message to the second node 20.

In S302, the second node 20 receives the reply message from the network server 30.

In S207, the network server 30 transmits a data transmission message to the first node 10. The data transmission message includes a destination address where the sharing data of the first node 10 should be transmitted, and the destination address is determined based on the sharing mode of the first node 10;

In S102, the first node 10 receives the data transmission message from the network server 30.

If the sharing request is permitted and the sharing mode of the first node 10 is a one-to-one sharing mode, the second node 20 may obtain the address of the first node 10, and establish a connection with the first node 10 directly. Then, as shown in FIG. 1, the following steps S103 and S303 will be performed.

In S103, the first node 10 transmits the sharing data to the second node 20 directly, if the sharing mode of the first node 10 is a one-to-one sharing mode.

In S303, the second node 20 receives the sharing data transmitted from the first node 10.

After the step S102 is performed, if the sharing request is permitted and the sharing mode of the first node 10 is a public sharing mode or a group sharing mode, the first node 10 and the second node 20 may establish a connection with the network server 30 respectively. As shown in FIG. 4, the following steps S104, S208, S304 will be performed.

In S104, the first node 10 transmits the sharing data to the network server 30 if the sharing mode of the first node 10 is a public sharing mode or a group sharing mode.

In S208, the network server 30 receives the sharing data transmitted from the first node 10, and transmits the sharing data to the second node 20.

In S304, the second node 20 receives the sharing data from the transmit server 30.

In some embodiments, the sharing data includes video data and audio data. If the sharing data of the first node 10 is screen image data, the data sharing method of the present disclosure may not support operation sharing for security reasons. Namely, the second node 20 can get screen date shared from the first node 10, but cannot directly operate the screen. This limitation is not only for security consideration, but also makes the implementation of the method easier.

In some embodiments, the sharing data includes navigation map and route data, which is very useful in some scenarios, such as a motorcade plan to a same destination. As different vehicles may have different navigation map and route data, if they run according to their own route, it may be difficult for the vehicles to uniformly reach the destination. But if the data sharing method of the present disclosure is implemented in these vehicles, they can assign a first vehicle to share its navigation screen, thus the rest vehicles can obtain the navigation screen and adjust their routes based on the shared navigation screen.

In some embodiments, the sharing data may be video data. For example, nowadays, more and more vehicles are equipped with front cameras or driving recorders. If a first vehicle output the camera or driving recorder image to the screen, and then share the screen image with other vehicles. Then, these vehicles may know the specific circumstances at the current position of the first vehicle, including road conditions, weather conditions and other information presented on the screen. The information will be of great help to other vehicles to make a better planning for their travel in advance. In another example, the driver of the vehicle may share the image from navigation or front camera to his family at any time, and let them know where he is, and what about the current driving conditions.

In some embodiments, the sharing data may be multimedia entertainment data. If a vehicle does not support video playback, he can watch video via screen sharing from other vehicles.

In some embodiment, the sharing data are compressed to a stream media data. In the stream media data, only the changing frames of the video are compressed and encoded, so as to save the bandwidth.

It should be noted that, the sharing process may be terminated by either the first node 10 or the second node 20.

According to an embodiment of the present disclosure, a system for sharing data is also provided. In some embodiments, the system may be mounted on a vehicle or a computer.

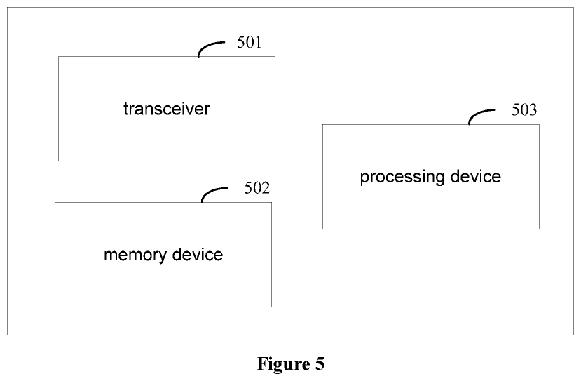

Referring to FIG. 5, the system may include a transceiver 501, a memory device 502 and a processing device 503. The processing device is configured to: after the transceiver 501 receives a sharing request message from a first node, obtain a sharing record of a second node based on an account of a second node, wherein the sharing request message includes the account of the second node which provides sharing data, and the sharing record is stored in the memory device; identify a sharing mode of the second node based on the sharing record; and control the transceiver to transmit a reply message to the first node based on the sharing mode of the second node.

In some embodiments, the system may include a transceiver 501 and a processing device 503. The processing device 503 is configured to: control the transceiver to transmit a sharing mode message to a network server, wherein the sharing mode message comprises a sharing mode of a first node; control the transceiver to receive a data transmission message from the network server, wherein the data transmission message includes a destination address where sharing data of the first node is transmitted, and the destination address is determined based on the sharing mode of the first node; and control the transceiver to transmit sharing data to the destination address.

In some embodiments, the system may include a transceiver 501 and a processing device 503. The processing device 503 is configured to: control the transceiver to transmit a sharing request message to a network server, wherein the sharing request message includes an account of a second node which provides sharing data; control the transceiver to receive a reply message from the network server, wherein the replay message indicates a sharing mode of the second node; and control the transceiver to receive sharing data from the network server or the second node according to the sharing mode of the second node.

More details about the system for sharing data can be found in the description of the method described above, and is not described in detail herein.

According to one embodiment, a non-transitory computer readable medium, which contains a computer program for sharing data, is provided. When the computer program is executed by a processor, it will instruct the processor to perform the steps of the method for sharing data.

There is little distinction left between hardware and software implementations of aspects of systems; the use of hardware or software is generally a design choice representing cost vs. efficiency trade-offs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for sharing data, comprising:
receiving, by a network server, a sharing request message from a first node, wherein the sharing request message comprises an account of a second node which provides sharing data;
obtaining a sharing record of the second node based on the account of the second node, wherein the sharing record is stored in the network server;
identifying a sharing mode of the second node based on the sharing record; and
transmitting a reply message to the first node based on the sharing mode of the second node.

2. The method according to claim 1, wherein the sharing mode comprises a one to one sharing mode, a group sharing mode or a public sharing mode.

3. The method according to claim 2, wherein if the sharing mode of the second node is a one to one sharing mode, the sharing record of the second node further comprises a predetermined account, and
the method further comprises:
comparing an account of the first node with the predetermined account; and
if the account of the first node is the same as the predetermined account, transmitting an address of the second node to the first node.

4. The method according to claim 2, wherein if the sharing mode of the second node is a group sharing mode, the sharing record of the second node further comprises an account list, and
the method further comprises:
identifying whether the account list comprises an account of the first node; and
if the account list comprises the account of the first node, transmitting the sharing data of the second node to the first node.

5. The method according to claim 1, wherein the sharing data comprises video data and audio data.

6. The method according to claim 1, wherein the sharing data are compressed to stream media data.

7. A method for sharing data, comprising:
transmitting, by a first node, a sharing mode message to a network server, wherein the sharing mode message comprises a sharing mode of the first node;
receiving a data transmission message from the network server, wherein the data transmission message comprises a destination address, and the destination address is determined based on the sharing mode of the first node; and
transmitting sharing data to the destination address.

8. The method according to claim 7, wherein the sharing mode comprises a one to one sharing mode, a group sharing mode or a public sharing mode.

9. The method according to claim 8, wherein if the sharing mode of the first node is a one to one sharing mode, the destination address in the data transmission message is an address of a second node.

10. The method according to claim 8, wherein if the sharing mode of the first node is a group sharing mode or a public sharing mode, the destination address in the data transmission message is an address of the network server.

11. A method for sharing data, comprising:
transmitting, by a first node, a sharing request message to a network server, wherein the sharing request message comprises an account of a second node which provides sharing data;
receiving a reply message from the network server, wherein the replay message indicates a sharing mode of the second node; and
receiving sharing data from the network server or the second node according to the sharing mode of the second node.

12. The method according to claim 11, wherein the sharing mode comprises a one to one sharing mode, a group sharing mode or a public sharing mode.

13. The method according to claim 12, wherein if the sharing mode of the second node is a one to one sharing mode, the first node receives the sharing data from the second node.

14. The method according to claim 12, wherein if the sharing mode of the second node is a group sharing mode or a public sharing mode, the first node receives the sharing data from the network server.

15-26. (canceled)
